(19) United States
(12) Patent Application Publication
(10) Pub. No.: US 2012/0312790 A1
(43) Pub. Date: Dec. 13, 2012

(54) PULSE CIRCULATOR

(75) Inventor: STEPHEN MOFFATT, St. Brelade (JE)

(73) Assignee: Applied Materials, Inc., Santa Clara, CA (US)

(21) Appl. No.: 13/490,052

(22) Filed: Jun. 6, 2012

Related U.S. Application Data
(60) Provisional application No. 61/495,872, filed on Jun. 10, 2011.

(51) Int. Cl. B23K 26/00

(52) U.S. Cl. 219/121.6

(57) ABSTRACT

A method and apparatus for annealing semiconductor substrates is disclosed. The apparatus has a pulsed energy source that directs pulsed energy toward a substrate. A homogenizer increases the spatial uniformity of the pulsed energy. A pulse shaping system shapes the temporal profile of the pulsed energy. A pulse circulator may be selected using a bypass system. The pulse circulator allows a pulse of energy to circulate around a path of reflectors, and a partial reflector allows a portion of the pulse to exit the pulse circulator with each cycle. The pulse circulator may have delaying elements and amplifying elements to tailor the pulses exiting from the circulator.

### CROSS-REFERENCE TO RELATED APPLICATIONS

This application claims benefit of U.S. Provisional Patent Application Ser. No. 61/495,872, filed Jun. 10, 2011, incorporated herein by reference.

### FIELD

Embodiments disclosed herein relate to methods and apparatus for manufacturing semiconductor devices. More specifically, apparatus and methods of annealing semiconductor substrates are disclosed.

### BACKGROUND

Thermal annealing is a commonly used technique in semiconductor manufacturing. A material process is generally performed on a substrate, introducing a material desirous of including in the substrate, and the substrate is subsequently annealed to improve the properties of the materially changed substrate. A typical thermal anneal process includes heating a portion of the substrate, or the entire substrate, to an anneal temperature for a period of time, and then cooling the material. In some cases, a portion of the material is melted and resolidified.

Pulse laser annealing is an attractive method of annealing semiconductor substrates. Pulsed laser energy provides a degree of control over the annealing process not afforded by omnibus annealing processes such as RTP. Common methods of generating laser pulses do not offer full flexibility to design pulse energies, durations, and intensity profiles that may be needed for some processes. For generating very short pulses of laser energy, generating means are mostly limited to q-switches, prism compressors, gratings and the like that offer limited flexibility in designing energy pulses.

Thus, there remains a need for new ways to generate and control pulsed energy for thermal processing.

### SUMMARY

A thermal processing apparatus is disclosed that has a pulsed energy source and a pulse circulator. The pulse circulator has at least a first and a second reflector, each of which may be a partial reflector. Each reflector has a reflective surface. The first reflector is positioned to receive energy reflected from the reflective surface of the second reflector at a reflective surface of the first reflector, and reflect the energy toward the second reflector. The second reflector transmits a portion of the energy incident on the reflective surface thereof.

The pulse circulator may also have circuit mirrors to increase the optical path length of the pulse circulator. The circuit mirrors may be actuated to vary the optical path length of the pulse circulator. Delay optics and amplifiers may be included in the pulse circulator.

The thermal processing apparatus may also include a homogenizer that increases spatial uniformity of an energy pulse, and a pulse shaping system for adjusting the temporal profile of a pulse. Multiple energy sources may be used to form a single pulse.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a plan view of a thermal processing apparatus according to one embodiment.

FIG. 1B is a schematic view of a pulse shaping system according to another embodiment.

FIG. 1C, is a schematic view of a homogenizer according to another embodiment.

FIG. 2 is a schematic view of a pulse circulator according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

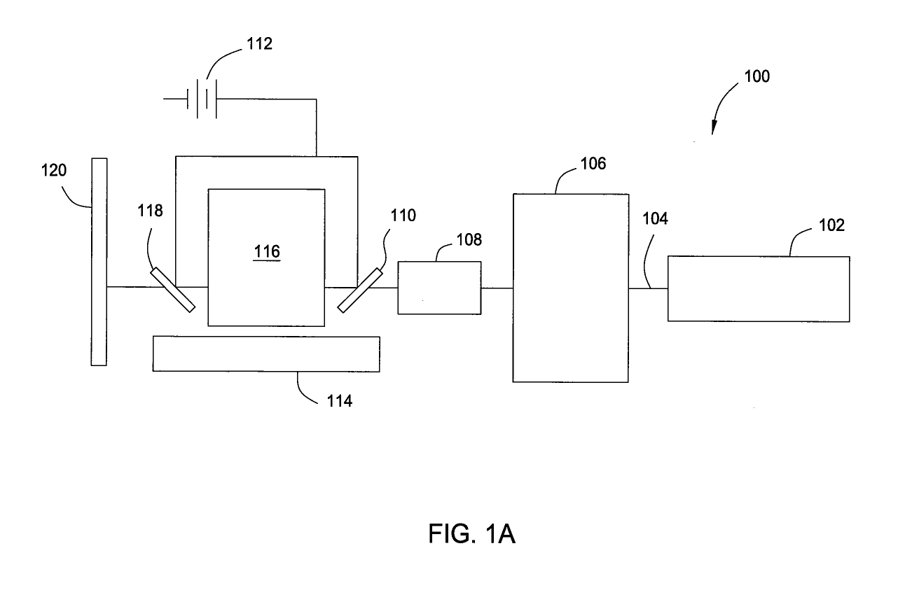

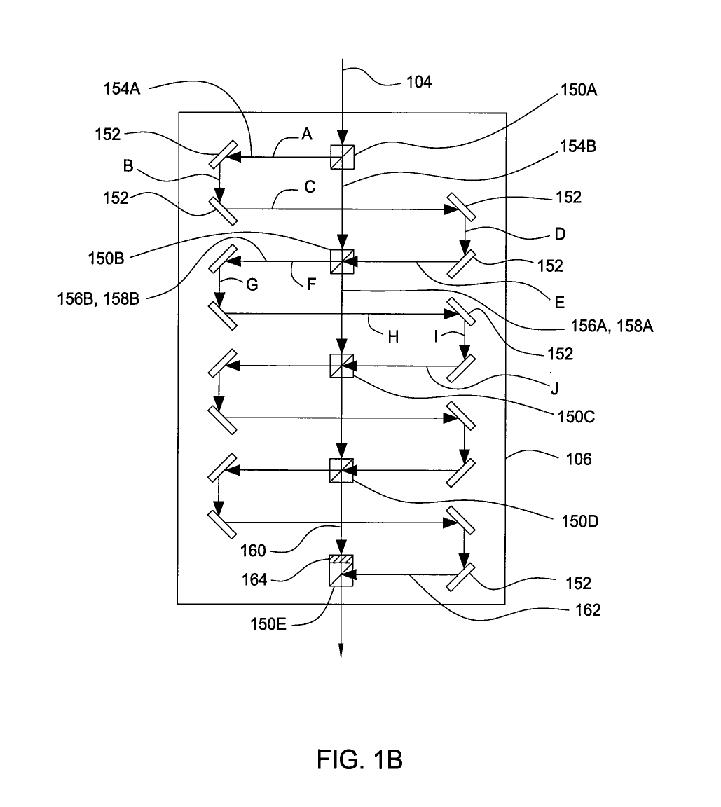

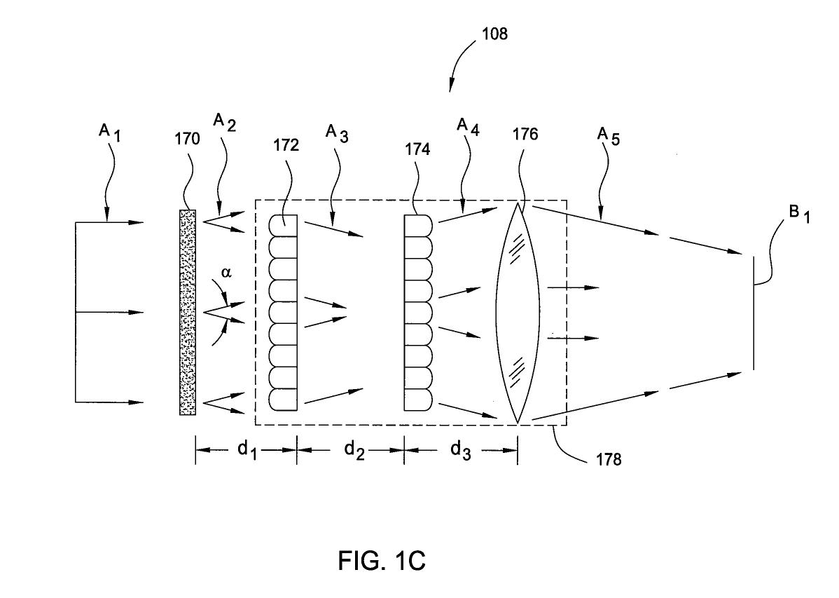

FIG. 1A is a plan view of a thermal processing apparatus 100 according to one embodiment. An energy source 102, which may be a laser source, forms an energy pulse 104. The energy source 102 may be a single laser or a plurality of lasers with joining optics to produce a single beam or pulse from the plurality of lasers. The energy source 102 may produce electromagnetic energy having a wavelength between about 200 nm and about 2,000 nm, such as between about 500 nm and about 1,000 nm, for example about 532 nm or about 810 nm. In an embodiment featuring a plurality of lasers, each laser may have the same wavelength, or some or all of the lasers may have different wavelengths. In one embodiment, the output of four frequency-doubled Nd:YAG lasers is merged into a single laser beam for pulsed output. It should be noted that any or all of the lasers may be continuous wave, pulsed, q-switched, and the like.

The energy pulse 104 is directed to an optional pulse shaping system 106. The pulse shaping system 106 subjects the energy pulse 104 to transformations that change the temporal shape of the pulse, or the intensity of the pulse as a function of time. The pulse shaping system 106 may divide the energy pulse 104 into sub-pulses using splitters, direct the sub-pulses through different paths having different path lengths, and then recombine the sub-pulses using combiners. Such a pulse shaping system may be used to modify the native temporal pulse shape produced by the energy source 102, if desired.

FIG. 1B schematically illustrates one embodiment of a pulse shaping system 106. The pulse shaping system of FIG. 1B may comprise a plurality of mirrors 152 (e.g., 16 mirrors are shown) and a plurality of beam splitters (e.g., reference numerals 150A-150E) that are used to delay portions of a laser energy pulse to provide a composite pulse that has a desirable pulse characteristics (e.g., pulse width and pulse profile). In one example, the laser energy pulse may be spatially coherent. A pulse of laser energy is split into two components, or sub-pulses 154A, 154B, after passing through the first beam splitter 150A. Neglecting losses in the various optical components, depending on the transmission to reflection ratio in the first beam splitter 150A, a percentage of the laser energy (i.e., X %) is transferred to the second beam splitter 150B in the first sub-pulse 154A, and a percentage of the energy (i.e., 1-X %) of the second sub-pulse 154B follows a path A-E (i.e., segments A-E) as it is reflected by multiple mirrors 152 before it strikes the second beam splitter 150B.

In one example, the transmission to reflection ratio of the first beam splitter 150A is selected so that 70% of the pulse's energy is reflected and 30% is transmitted through the beam splitter. In another example the transmission to reflection ratio of the first beam splitter 150A is selected so that 50% of the pulse's energy is reflected and 50% is transmitted through the beam splitter. The length of the path A-E, or sum of the lengths of the segments A-E (i.e., total length=A+B+C+D+E as illustrated in FIG. 1B), will control the delay between sub-pulse 154A and sub-pulse 154B. In general by adjusting the difference in path length between the first sub-pulse 154A and the second sub-pulse 154B a delay of about 3.1 nanoseconds (ns) per meter can be realized.

The energy delivered to the second beam splitter 150B in the first sub-pulse 154A is split into a second sub-pulse 156A that is directly transmitted to the third beam splitter 150C and a second sub-pulse 156B that follows the path F-J before it strikes the third beam splitter 150C. The energy delivered in the second sub-pulse 154B is also split into a third sub-pulse 158A that is directly transmitted to the third beam splitter 150C and a third sub-pulse 158B that follows the path F-J before it strikes the third beam splitter 150C. This process of splitting and delaying each of the sub-pulses continues as each of the sub-pulses strikes subsequent beam splitters (i.e., reference numerals 150D-E) and mirrors 152 until they are all recombined in the final beam splitter 150E that is adapted to primarily deliver energy to the next component in the thermal processing apparatus 100. The final beam splitter 150E may be a polarizing beam splitter that adjusts the polarization of the energy in the sub-pulses received from the delaying regions or from the prior beam splitter so that it can be directed in a desired direction.

In one embodiment, a waveplate 164 is positioned before a polarizing type of final beam splitter 150E so that its polarization can be rotated for the sub-pulses following path 160. Without the adjustment to the polarization, a portion of the energy will be reflected by the final beam splitter and not get recombined with the other branch. In one example, all energy in the pulse shaping system 106 is S-polarized, and thus the non-polarizing cube beam splitters divide incoming beams, but the final beam splitter, which is a polarizing cube, combines the energy that it receives. The energy in the sub-pulses following path 160 will have its polarization rotated to P, which passes straight through the polarizing beam splitter, while the other sub pulses following path 162 are S-polarized and thus are reflected to form a combined beam.

In one embodiment, the final beam splitter 150E comprises a non-polarizing beam splitter and a mirror that is positioned to combine the energy received from the delaying regions or from the prior beam splitter. In this case, the beam splitter will project part of the energy towards a desired point, transmit another part of the energy received towards the desired point, and the mirror will direct the remaining amount of energy transmitted through the beam splitter to the same desired point. One will note that the number of times the pulse is split and delayed may be varied by adding beam splitting type components and mirrors in the configuration as shown herein to achieve a desirable pulse duration and a desirable pulse profile. While FIG. 1B illustrates a pulse shaping system design that utilizes four beam delaying regions, which contain a beam splitter and mirrors, this configuration is not intended to be limiting as to the scope of the invention.

Referring to FIG. 1A, the thermal processing apparatus 100 also has an optional homogenizer 108 for increasing the spatial uniformity of the energy 104. The homogenizer 108 employs elements that reduce or eliminate spatial coherency of the energy 104, increase the number of spatial modes of the energy 104, or spatially randomize the energy 104. One or more refractive arrays, such as lens arrays, may be transmissively coupled with one or more focusing or defocusing elements, such as lenses, to increase the spatial uniformity of energy density of the energy 104 to about 10% or better, for example about 5% or better.

FIG. 1C is a schematic view of a homogenizer 108 according to one embodiment. The homogenizer of FIG. 1C receives an incident beam A₁ of spatially coherent electromagnetic energy and produces a uniform energy field at the image plane B₁. A beam integrator assembly 178, which contains a pair of micro-lens arrays 172 and 174 and lens 176, homogenizes the energy passing through the beam integrator assembly 178. It should be noted that the term micro-lens array, or fly's-eye lens, is generally meant to describe an integral lens array that contains multiple adjacent lenses. The beam integrator assembly 178 of FIG. 1C generally works best using an incoherent source or a broad partially coherent source whose spatial coherence length is much smaller than a single micro-lens array's dimensions. In short, the beam integrator assembly 178 homogenizes the beam by overlapping magnified images of the micro-lens arrays at a plane situated at the back focal plane of the lens 176. The lens 176 should be well corrected so as minimize aberrations including field distortion. Also, the size of the image field is a magnified version of the shape of the apertures of the first micro-lens array 172, where the magnification factor is given by F/f₁ where f₁ is the focal length of the micro-lenses in the first micro-lens array 172 and F is the focal length of lens 176.

In one example, a lens 176 that has a focal length of about 175 mm, and micro-lenses in the micro-lens array having a 4.75 mm focal length, are used to form an 11 mm square field image. One will note that many different combinations for these components can be used, but generally the most efficient homogenizers will have a first micro-lens array 172 and second micro-lens array 174 that are identical. The first and second micro-lens arrays 172 and 174 may be spaced a distance apart so that the energy density (Watts/mm²) delivered to the first micro-lens array 172 is increased, or focused, on the second micro-lens array 174. To avoid damaging the second micro-lens array 174 by focusing energy density of the second micro-lens array 174 exceeding the damage threshold of the any component of the second micro-lens array 174, the second micro-lens array 174 is spaced a distance d₂ from the first micro-lens array 172 equal to the focal length of the lenslets in the first micro-lens array 172.

In one example, each of the first and second micro-lens arrays 172 and 174 contains 7,921 micro-lenses (i.e., an 89×89 array of lenslets) that are a square shape and that have an edge length of about 300 microns. The lens 176, which may be a Fourier lens, is generally used to integrate the image received from the micro-lens arrays 172 and 174 and is spaced a distance d₃ from the second micro-lens array 174.

A random diffuser 170 may be placed within the homogenizer 108 so that the uniformity of energy A₅ leaving the homogenizer 108 is improved in relation to the incoming energy A₁. In this configuration, the incoming energy A₁ is diffused by the placement of a random diffuser 170 prior to the energy A₂, A₃ and A₄ being received and homogenized by the first micro-lens array 172, second micro-lens array 174 and lens 176, respectively. The random diffuser 170 will cause the pulse of incoming energy (A₁) to be distributed over a wider range of angles (α₁) to reduce the contrast of the projected beam and thus improve the spatial uniformity of the pulse. The random diffuser 170 generally causes the light passing through it to spread out so that the irradiance (W/cm²) of energy A₃ received by the second micro-lens array 174 is less than without the diffuser. The random diffuser 170 is also used to randomize the phase of the beam striking each micro-lens array 172 and 174. This additional random phase improves the spatial uniformity by spreading out the high intensity spots observed without the diffuser.

In general, the random diffuser 170 is a narrow angle optical diffuser that is selected so that it will not diffuse the received energy in a pulse at an angle greater than the acceptance angle of the lens that it is placed before. In one example, the random diffuser 170 is selected so that the diffusion angle α₁ is less than the acceptance angle of the micro-lenses in the first micro-lens array 172 or the second micro-lens array 174. In one embodiment, the random diffuser 170 comprises a single diffuser, such as a 0.5° to 5° diffuser that is placed prior to the first micro-lens array 172. In another embodiment, the random diffuser 170 comprises two or more diffuser plates, such as 0.5° to 5° diffuser plates that are spaced a desired distance apart. In one embodiment, the random diffuser 170 may be spaced a distance d₁ away from the first micro-lens array 172 so that the first micro-lens array 172 can receive substantially all of the energy delivered in the incoming energy A₁.

Referring to FIG. 1A, the thermal processing apparatus 100 further comprises a pulse circulator 116. The pulse circulator 116 receives a pulse of energy and circulates the energy to generate a delay of all or part of the incoming pulse. The pulse circulator 116 employs elements that may include splitters, partial reflectors, total reflectors, adjustable reflectors, and the like, to circulate the energy pulse.

In one aspect, the pulse circulator employs optical elements to circulate a pulse of electromagnetic energy. The pulse circulator may have a first reflector, for example a one-way mirror, that receives an incoming pulse, a second reflector, for example a partial mirror, that receives the pulse from the first reflector, and one or more circuit mirrors that direct energy reflected from the second reflector back to the first reflector. The second reflector transmits a certain percentage of the energy received from the first reflector each time the energy circulates, resulting in a portion of the original energy pulse being transmitted out of the pulse circulator 116 each time the energy travels around the pulse circulator 116 until the energy is effectively extinguished. Thus, in some embodiments, the pulse circulator 116 may be a pulse divider.

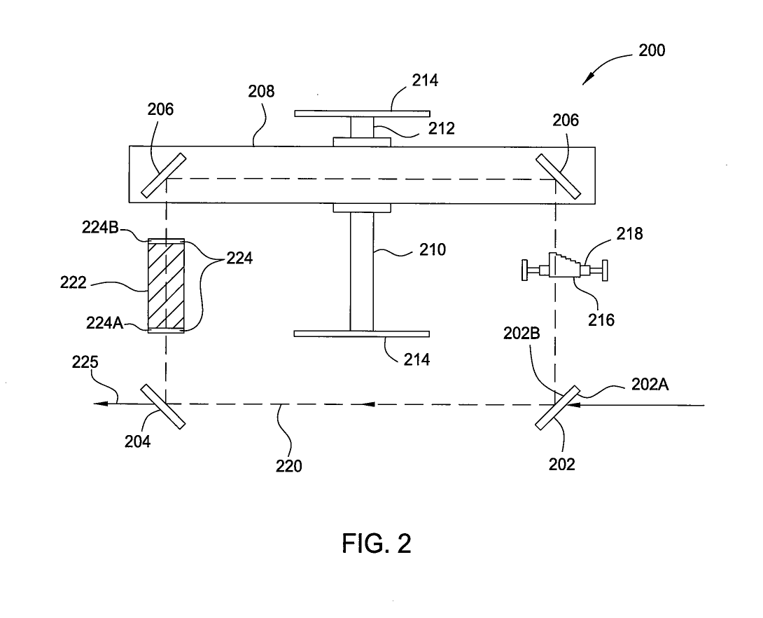

FIG. 2 is a schematic view of a pulse circulator 200 usable in the thermal processing apparatus 100 according to one embodiment. The pulse circulator 200 has a first reflector 202 with a transmitting surface 202A and a reflecting surface 202B. The transmitting surface 202A allows light incident on the transmitting surface 202A to pass through the first reflector 202, and the reflecting surface 202B reflects light incident on the reflecting surface 202B.

The pulse circulator 200 also has a second reflector 204 that transmits a portion of radiation incident on the second reflector 204 and reflects a portion of the incident radiation. The first reflector 202 is positioned to receive radiation reflected from the second reflector 204 on the reflecting surface 202B of the first reflector 202 and reflect the radiation back to the second reflector 204.

One or more circuit reflectors 206 may be included in the pulse circulator 200. Two circuit reflectors 206 may be used to direct light reflected from the second reflector 204 to the reflective surface 202B of the first reflector 202. Light entering the pulse circulator 200 through the transmissive surface 202A of the first reflector 202 cycles around the reflectors of the pulse circulator 200 following a circuit path 220. Every time the energy cycles around the circuit path 220 to the second reflector 204, a portion of the energy is released from the pulse circulator 200 in a sub-pulse 225, leaving the remaining energy to cycle. The pulse circulator 200 thus converts a single pulse of incoming energy into a series of sub-pulses of declining intensity. Intensity of the sub-pulses declines geometrically according to the transmissivity of the second reflector 204.

Referring back to FIG. 1A, the thermal processing apparatus 100 also includes a substrate support 120 for positioning a substrate to be subjected to the pulsed energy 104. A bypass system 114 may be included to allow the pulse circulator 116 to be bypassed and the energy 104 sent directly to the substrate on the substrate support 120. In this way, the thermal processing apparatus 100 may be used to direct a pulse of energy 104 to a substrate for thermal processing and to direct a series of sub-pulses of declining intensity to the substrate before or after the thermal processing.

The bypass system 114 may be selected by a switchable reflector 110, for example an LCD mirror or a microelectromechanical device, that may be switched from essentially full transmission to essentially full reflection by applying a voltage from a power source 112. When the switchable reflector 110 is energized, the surface of the switchable reflector 110 facing the incoming energy becomes reflective, directing the incoming energy to the bypass system 114. The bypass system 114 contains reflectors that direct the energy around the pulse circulator 116 to a second switchable reflector 118 that aligns the energy from the bypass system 114 toward the substrate support 120. The switchable reflectors 110 and 118 are generally operated synchronously so that when the switchable reflector 110 is reflective, the switchable reflector 118 is also reflective, and when the switchable reflector 110 is transmissive, the switchable reflector 118 is also transmissive.

In operation, the thermal processing apparatus 100 may be configured to direct pulses of processing radiation to the substrate support 120 to thermally treat a substrate positioned on the substrate support 120. Following the thermal treatment, the thermal processing apparatus 100 may be configured to direct pulses of cool-down radiation to the substrate support 120 to cause a controlled cooling of the substrate following the thermal treatment. In one aspect, each cool-down pulse transfers energy to the substrate surface, increasing its temperature or slowing its rate of cooling in the area affected by the energy.

The pulse circulator 116 of FIG. 1A or FIG. 2 may be useful for thermal processing methods featuring controlled cooling of a substrate. In some such methods, cooling is controlled after heating to adjust the final properties of the substrate following the treatment. Using the pulse circulator 116 of FIG. 1A or the pulse circulator 200 of FIG. 2, energy may be added to the substrate at a controlled rate as the substrate cools to influence the rate of different morphology processes, and therefore influence the morphology of the final product.

The pulse circulator 116 may be configured to produce a series of pulses spaced apart by a rest duration. The rest duration may be selected to allow the substrate temperature in the area affected by the cool-down pulses to decline by a specified amount. A cool-down pulse may then raise the temperature of the affected area by an amount less than the temperature decline during the immediately prior rest duration. The cool-down pulses generally have an intensity defined by the following relationship:

Iₙ=I₀(1−T)ⁿ

where Iₙ is the intensity of the n^{th} pulse, I₀ is the intensity of the incident pulse, and T is the transmissivity of the second reflector 204. In one aspect, the path length of the pulse circulator 116 may be set such that the initial intensity I₀ of the pulse entering the pulse circulator 116 is substantially the same as pulses used in thermal processing of the substrate, and the rest duration between each pulse allows the thermal energy of the affected area of the substrate to decline by a desired amount between the cool-down pulses.

In one embodiment, the thermal processing includes melting a portion of the substrate surface, and the subsequent cool-down pulses perform a controlled solidification or recrystallization of the substrate surface at a rate below the natural rate of solidification due to radiation and dissipation of surface energy of the substrate alone. Each pulse delivered during thermal processing may perform a controlled melting of a portion of the substrate surface, progressing a melt front through a depth of the surface. Then, a portion of the cool-down pulses may each perform a controlled remelt of a portion of the substrate surface, progressing a solidification front through the depth of the surface. In order to perform such a method, the switchable reflectors 110 and 118 are energized to bypass the pulse circulator 116 while the thermal processing pulses are delivered. Any number of thermal processing pulses may be delivered during the thermal processing operation. The switchable reflectors 118 may then be de-energized and a pulse of energy routed through the pulse circulator 116 to perform a controlled cooling of the processed surface.

In one aspect, the circuit reflectors 206 of FIG. 2 may be adjustable. The circuit reflectors 206 may be carried on a support 208 that is coupled to a track 210 by a linear actuator 212. Limiters 214 may be provided to limit the range of motion of the actuator 212, if desired. The configuration of FIG. 2 allows adjustment of the path length of the pulse circulator 200 by moving the circuit reflectors 206 closer to or further from the first and second reflectors 202 and 204. Adjusting the path length of the circulator affects the interval of time between pulses emerging from the second reflector 204.

Delay may also be introduced into the pulse circulator 200 by including an optical element with an elevated refractive index compared to the ambient medium of the pulse circulator 200. Such optical elements include solids, liquids, and gases, and the degree of delay may be modulated by adjusting the thickness of the refractive medium through which the light passes. In one example, a delay optic 216 of varying thickness may be disposed along the optical path of the pulse circulator 200. The thickness of the delay optic 216 is usually stepped, rather than angled, to maintain a perpendicular incidence of the light on the delay optic 216 to avoid redirection of the light by refraction. A 1 cm thick piece of glass (n≈1.5) disposed in a 1 m optical path will add about 0.5% to the interval between pulses emerging from the second reflector 204. A 1 cm thick piece of transparent carbon (i.e. diamond, n≈2.4), will add about 1.4% to the interval in a 1 m circuit. The thickness of the material may be stepped, and the delay optic 216 actuated by a linear actuator 218 to position a selected step in the optical path to select a delay value. The delay optic 216 may be a single substance or a composite. In one aspect, the delay optic 216 may be a shaped vial of fluid having a desired refractive index.

The intensity relationship between each cool-down pulse may be further influenced by adding optical elements to the pulse circulator 200. In one aspect, an amplifier 222 may be added to the path of energy circulating in the pulse circulator 200. The amplifier 222 is generally a medium susceptible to stimulated emission at wavelengths similar to, or equal to, the wavelength of the circulating energy. For example, if the circulating energy is produced by a Nd:YAG laser, the amplifier 222 may be an Nd:YAG crystal. The amplifier 222 may be pumped prior to circulating a pulse through the pulse circulator 200, such that energy passing through the amplifier 222 causes the amplifier 222 to emit radiation substantially coherent with the incident energy. The exact decay profile of pulses emerging from the pulse circulator 200 may thus be adjusted by adding energy to each pulse at a controlled rate.

In some aspects, the amplifier 222 may be operated as a pulse intensifier. For example, as the pulse circulates through the pulse circulator 200, the amplifier may be recharged with each pass, adding more energy to the pulse with each pass such that each pulse exiting the pulse circulator 200 has greater intensity than the last. In one embodiment, a second pulse circulator may be integrated with the pulse circulator 200 to circulate a charging pulse in synchronization with the circulating pulse. Alternately, the amplifier 222 of the pulse circulator 200 may be pumped by a pulsed light source.

In other embodiments the amplifier 222 may be charged at a frequency different from the oscillation frequency of the circuit such that a pulse circulates multiple times between charges applied to the amplifier. In such embodiments, the pulse circulator 200 produces pulses having a periodic intensity pattern, with the intensity of the pulses rising and falling according to the relationship between the circulation frequency and the charging frequency of the amplifier.

The amplifier 222 may also have reflectors 224 to form an oscillator cavity in the amplifier 222 to allow for a broader range of amplification options. A first reflector 224A will usually be a total reflector while a second reflector 224B may be a partial reflector with fixed or variable transmissivity. The properties of the oscillator cavity may be varied, along with the optical path length of the pulse circulator 200, to provide pulses having virtually any periodicity and intensity pattern. In one aspect, the pulse circulator 200 may be operated as a ring laser.

While the foregoing is directed to embodiments of the invention, other and further embodiments of the invention may be devised without departing from the basic scope thereof.

What is claimed is:

1. A pulse circulator for a thermal processing device, the pulse circulator comprising:
a pulsed radiation source;
a first reflector with a reflecting surface and a transmitting surface opposite the reflecting surface, the first reflector positioned to receive a radiation pulse from the pulsed radiation source; and
a second reflector that transmits a portion of incident radiation and reflects a portion of incident radiation positioned to receive a pulse of radiation from the first reflector and reflect a portion of the pulse of radiation, wherein the first reflector is positioned to receive the radiation reflected from the second reflector on the reflecting surface of the first reflector and reflect the radiation back to the second reflector.

2. The pulse circulator of claim 1, further comprising a plurality of circuit mirrors disposed to form an optical circuit with the first and second reflectors.

3. The pulse circulator of claim 2, wherein the plurality of circuit mirrors is fastened to an actuated positioner.

4. The pulse circulator of claim 3, wherein the actuated positioner is linearly actuated along an axis perpendicular to a center line from the first reflector to the second reflector.

5. The pulse circulator of claim 1, further comprising a delay optics.

6. The pulse circulator of claim 5, wherein the delay optics comprises a refractive element.

7. The pulse circulator of claim 1, further comprising an amplifier.

8. A thermal processing apparatus, comprising:
a substrate support;
a source of pulsed energy; and
a pulse circulator disposed between the source of pulsed energy and the substrate support, the pulse circulator comprising:
a first reflector with a reflecting surface and a transmitting surface opposite the reflecting surface; and
a second reflector that transmits a portion of incident energy and reflects a portion of incident energy positioned to receive a pulse of energy from the first reflector and reflect a portion of the pulse, wherein the first reflector is positioned to receive the energy reflected from the second reflector on the reflecting surface of the first reflector and reflect the energy back to the second reflector.

9. The thermal processing apparatus of claim 8, wherein the pulsed energy source is a pulsed laser source.

10. The thermal processing apparatus of claim 9, further comprising a homogenizer between the pulsed laser source and the pulse circulator.

11. The thermal processing apparatus of claim 10, further comprising a bypass optic for the pulse circulator with switchable mirrors to direct a laser pulse to the pulse circulator or the bypass optic.

12. The thermal processing apparatus of claim 8, wherein the pulse circulator further comprises an actuated delay optic.

13. The thermal processing apparatus of claim 12, wherein the actuated delay optic comprises a plurality of reflectors.

14. The thermal processing apparatus of claim 12, further comprising a homogenizer between the pulsed energy source and the pulse circulator.

15. The thermal processing apparatus of claim 12, further comprising a bypass optic that has switchable mirrors to direct a pulse of energy to the pulse circulator or to the bypass optic.

16. The thermal processing apparatus of claim 11, further comprising a pulse shaping optical system.

17. A method of thermally processing a substrate, comprising:
directing a first pulse of electromagnetic energy toward the substrate;
directing a second pulse of electromagnetic energy into a pulse circulator that forms a plurality of pulses from the second pulse, wherein the plurality of pulses decline in intensity; and
directing the plurality of pulses toward the substrate.

18. The method of claim 17, wherein the first pulse anneals a portion of the substrate and the plurality of pulses causes a programmed cooling of the portion of the substrate.

19. The method of claim 18, wherein the first pulse melts a portion of the substrate and the plurality of pulses causes a progressive recrystallization of the portion of the substrate.

20. The method of claim 17, wherein directing the first pulse of electromagnetic energy toward the substrate comprises operating a bypass optic to direct the first pulse away from the pulse circulator, and directing the second pulse of electromagnetic energy toward the pulse circulator comprises operating the bypass optic to direct the second pulse into the pulse circulator.
